(19) United States
(12) Patent Application Publication
(10) Pub. No.: US 2014/0210393 A1
(43) Pub. Date: Jul. 31, 2014

(54) CAPACITOR PRECHARGE CIRCUIT, MOTOR DRIVE SYSTEM, ELECTRIC POWER STEERING SYSTEM AND AIRBAG SYSTEM

(71) Applicants: Nobuyasu Kanekawa, Tokyo (JP); Ryoichi Kobayashi, Hitachinaka-shi (JP); Tomonobu Koseki, Hitachinaka-shi (JP); Chihiro Sato, Hitachinaka-shi (JP); Tomishige Yatsugi, Hitachinaka-shi (JP); Hirofumi Kurimoto, Hitachinaka-shi (JP)

(72) Inventors: Nobuyasu Kanekawa, Tokyo (JP); Ryoichi Kobayashi, Hitachinaka-shi (JP); Tomonobu Koseki, Hitachinaka-shi (JP); Chihiro Sato, Hitachinaka-shi (JP); Tomishige Yatsugi, Hitachinaka-shi (JP); Hirofumi Kurimoto, Hitachinaka-shi (JP)

(73) Assignee: HITACHI AUTOMOTIVE SYSTEM, LTD., Hitachinaka-shi, Ibaraki (JP)

(21) Appl. No.: 14/238,054

(22) PCT Filed: Jul. 11, 2012
(86) PCT No.: PCT/JP2012/067669

§ 371 Date: Feb. 10, 2014

(30) Foreign Application Priority Data
Aug. 21, 2011 (JP) 2011-189177

(51) Int. Cl. H02J 7/00; B60R 21/26; H02P 29/00

(52) U.S. Cl. CPC H02J 7/007; H02P 29/00; B60R 21/26
USPC 318/494; 307/38; 280/742

(57) ABSTRACT

A loss (generation of heat) is reduced in a capacitor precharge circuit, thereby reducing the size of the circuit.

The capacitor precharge circuit according to the present invention divides a power supply voltage using a switched capacitor voltage divider circuit, thereby carrying out charging while suppressing a both-terminal voltage of the capacitor that is subject to the charging (refer to FIG. 1).

### TECHNICAL FIELD

The present invention relates to a circuit that precharges a capacitor.

### BACKGROUND ART

An electric power steering (EPS) system needs a capacitor (electrolytic capacitor) having a large capacity within a power circuit in order to instantaneously supply a large current to a motor. Similarly, in an airbag system, even if an electric power supply from a battery is cut off at the time of collision of a motor vehicle, a back-up power circuit with the capacitor (electrolytic capacitor) having a large capacity is provided so as to be able to ignite an airbag by causing an electric current to flow into a squib inside the airbag.

When a power is turned on, there is a possibility that an inrush of current with respect to the capacitor may cause a failure of the capacitor so that there is a need for a soft-start precharge circuit that gradually carries out charging while suppressing the inrush of current.

Below referenced PTL 1 discloses a precharge circuit in which a, switching circuit 22 switches a circuit connection between a precharge passage 51 and a power supply passage 52.

### CITATION LIST

### Patent Literature

PTL 1: JP-A-2007-336609

### SUMMARY OF INVENTION

### Technical Problem

In a precharge circuit in the related art disclosed in PTL 1, a capacitor is charged as a current is regulated via a resistor, thereby realizing a soft-start precharge circuit. However, because of a great loss (generation of heat) in the resistor for regulating current, there is a need for a resistor having a large capacity, thereby causing difficulty in obtaining an integrated circuit.

Specifically, if a voltage VB is applied to a capacitor C₀, with respect to energy C₀VB² supplied from a power, energy C₀VB²/2 is stored in the capacitor C₀. The remaining C₀VB²/2 becomes a loss (generation of heat) in the resistor for regulating current. If the voltage VB is suddenly applied while a both-terminal voltage V_{C} of the capacitor C₀at an initial stage of charging is low, a potential difference VB-V_{C} is added to the capacitor, thereby causing the loss (generation of heat);

The present invention is made to solve the above-described problem. An object thereof is to reduce the loss (generation of heat) in a capacitor precharge circuit and to decrease a size of the circuit.

### Solution to Problem

A capacitor precharge circuit according to the present invention divides a power supply voltage using a switched capacitor voltage divider circuit, thereby carrying out charging while suppressing a both-terminal voltage of the capacitor that is subject to the charging.

### Advantageous Effects of Invention,

In a capacitor precharge circuit according to the present invention, it is possible to suppress a loss (generation of heat) within a circuit and to decrease the size of the circuit.

### BRIEF DESCRIPTION OF DRAWINGS

FIG. 1 is a schematic circuit diagram of a precharge circuit 10 according to an embodiment 1.

FIG. 2 is a schematic circuit diagram in a case where a switched capacitor voltage divider circuit 11 has only one capacitor for dividing voltage.

FIG. 3 is a diagram illustrating a state of a change in switching a voltage applied to both terminals of a capacitor C₀.

FIG. 4 is a diagram illustrating a change in a both-terminal voltage V_{C} of the capacitor C₀ in each of Mode 1 and Mode 2.

FIG. 5 is a diagram illustrating connection states of the capacitor C₀and a capacitor C₁ for dividing voltage in Mode 2.

FIG. 6 is a diagram illustrating connection states of the capacitor C₀ and the capacitor C₁ for dividing voltage in Mode 1.

FIG. 7 is a diagram illustrating detailed configurations of the switched capacitor voltage divider circuit 11 and operation in Mode 2.

FIG. 8 is a diagram illustrating detailed configurations of the switched capacitor voltage divider circuit 11 and operations in Mode 1.

FIG. 9 is a schematic circuit diagram of the precharge circuit 10 according to an embodiment 2.

FIG. 10 is a diagram illustrating a state of a change in switching a voltage applied to both terminals of the capacitor C₀ according to the embodiment 2.

FIG. 11 is a diagram illustrating connection states of the capacitor C₀ and the capacitor for dividing voltage in Mode 3.

FIG. 12 is a diagram illustrating connection states of the capacitor C₀ and the capacitor for dividing voltage in Mode 2.

FIG. 13 is a diagram illustrating connection states of the capacitor C₀ and the capacitor for dividing voltage in Mode 1.5.

FIG. 14 is a diagram illustrating connection states of the capacitor C₀ and the capacitor for dividing voltage in Mode 1.

FIG. 15 is a diagram illustrating a change in the both-terminal voltage V_{C} of the capacitor C₀ according to the embodiment 2.

FIG. 16 is a diagram illustrating detailed configurations of the switched capacitor voltage divider circuit 11 and operations in Mode 3 according to the embodiment 2.

FIG. 17 is a diagram illustrating detailed configurations of the switched capacitor voltage divider circuit 11 and operations in Mode 2 according to the embodiment 2.

FIG. 18 is a diagram illustrating detailed configurations of the switched capacitor voltage divider circuit 11 and operations in Mode 1.5 according to the embodiment 2.

FIG. 19 is a diagram illustrating detailed configurations of the switched capacitor voltage divider circuit 11 and operations in Mode 1 according to the embodiment

FIG. 20 is a schematic circuit diagram of the precharge circuit 10 according to an embodiment 3.

FIG. 21 is a diagram illustrating a change in the both-terminal voltage V_{C} of the capacitor C₀ according to the a embodiment 3.

FIG. 22 is a diagram illustrating an example of a control circuit of the switched capacitor voltage divider circuit 11 according to an embodiment 4.

FIG. 23 is a diagram illustrating another configuration example of a control circuit of the switched capacitor voltage divider circuit 11 according to the embodiment 4.

FIG. 24 is a diagram illustrating a time-dependent change of the both-terminal voltage V_{C} and a capacitor charging current I_{C} in a case where a switching frequency fsw of the switched capacitor voltage divider circuit 11 is changeable.

FIG. 25 is a diagram illustrating an example of a case where the switching frequency fsw is changed in an aspect different from that of FIG. 24.

FIG. 26 is a diagram illustrating an example of a case where the switching frequency fsw is changed in another aspect different from those of FIGS. 24 and 25.

FIG. 27 is a configuration diagram of a motor drive system 100 according to an embodiment 6.

FIG. 28 is a configuration diagram of an electric power steering system 200 according to an embodiment 7.

FIG. 29 is a configuration diagram of an airbag system 300 according to an embodiment 8.

### DESCRIPTION OF EMBODIMENTS

### Embodiment 1

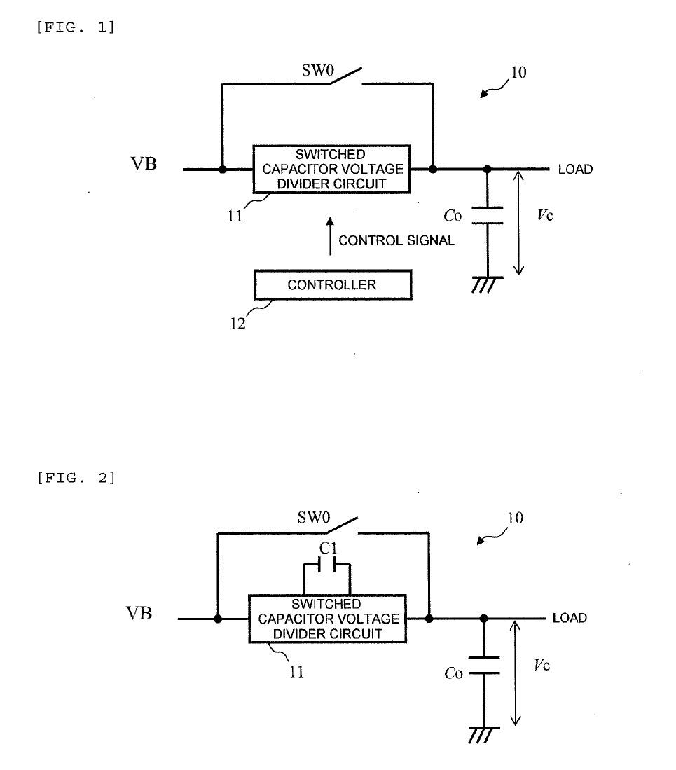

FIG. 1 is a schematic circuit diagram of a precharge circuit 10 according to an embodiment 1 of the present invention. The precharge circuit 10 includes a switched capacitor voltage divider circuit 11, a controller 12 and a switch SW0. Here, only an overview of the circuit in its entirety is described for a conceptual description of the precharge circuit 10, and detailed circuit diagrams will be described after FIG. 5 referenced below.

A battery voltage VB is a voltage supplied from a power generator or a battery. The controller 12 controls the switched capacitor voltage divider circuit 11 and the switch SW0. The switch SW0 is a switch switching whether or not the battery voltage VB is directly supplied to a load. The switched capacitor voltage divider circuit 11 divides the power supply voltage VB by dividing the power supply voltage VB between itself and a capacitor C₀. Accordingly, it is possible to gradually charge the capacitor C₀ without a sudden increase in a both-terminal voltage V_{C} of the capacitor C₀.

Specifically, the switch SW0 is open at the time of supplying the power, and the switched capacitor voltage divider circuit 11 divides the battery voltage VB to apply to the capacitor C₀. As an electrical charge is stored in the capacitor C₀, the switched capacitor voltage divider circuit 11 changes a voltage division ratio and applies a voltage which increases in phases. When the electrical charge is stored in the capacitor C₀ so that a both-terminal voltage approaches VB, the switch SW0 is closed.

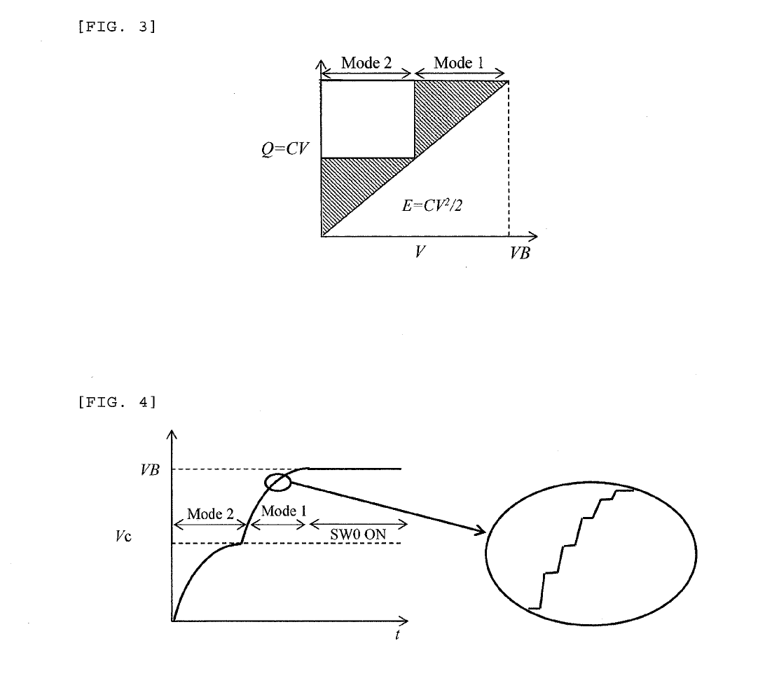

FIG. 2 is a schematic circuit diagram in a case where the switched capacitor voltage divider circuit 11 has only one capacitor (C₁) for dividing voltage. The controller 12 is omitted. The rest is the same as above. If there is one capacitor for dividing voltage, it is possible to switch the voltage applied to both terminals of the capacitor C₀in two phases of VB/2 and VB.

FIG. 3 is a diagram illustrating a state, of a change in switching the voltage applied to both terminals of a capacitor: C₀. A state of the both-terminal voltage of the capacitor, C₀ to be VB/2 is referred to as Mode 2, and a state of the both-terminal voltage to be VB, is referred to as Mode 1. A hatching portion in FIG. 3 denotes a region corresponding to a loss (generation of heat).

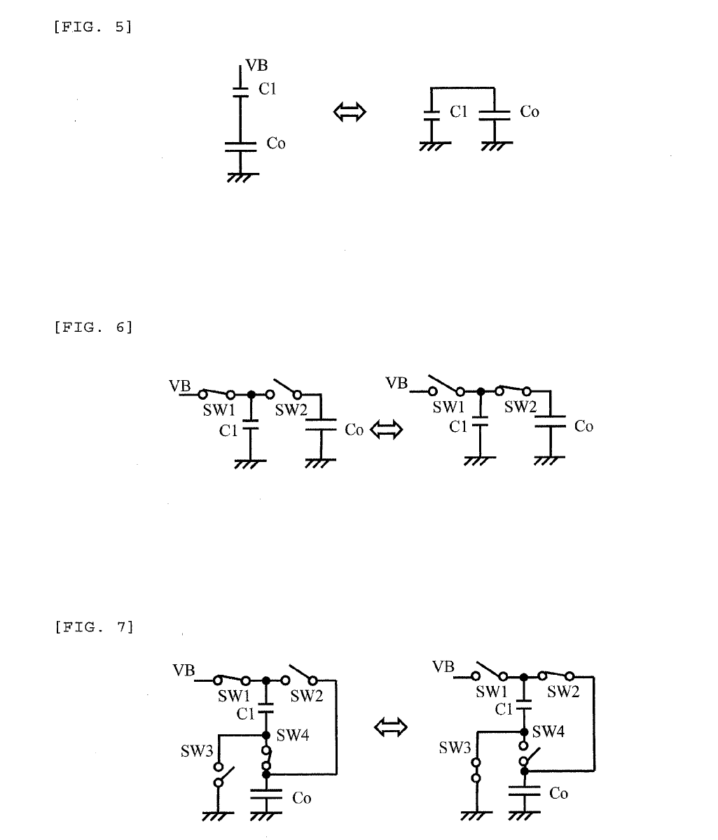

FIG. 4 is a diagram illustrating a change in the both-terminal voltage V_{C} of the capacitor C₀ in each of Mode 1 and Mode 2. In each Mode, the both-terminal voltage VC of the capacitor C₀ approaches an asymptotic value of each Mode. Hereinafter, the asymptotic value in each Mode will be described.

FIG. 5 is a diagram illustrating connection states of the capacitor C₀ and a capacitor C₁ for dividing voltage in Mode 2. In Mode 2, the controller 12 causes the capacitor C₀ and a capacitor C₁ for dividing voltage to repeatedly alternate between a state of being connected in series and a state of being connected in parallel. Accordingly, the battery voltage VB is divided into VB/2

In fact, as illustrated in FIG. 4, the both-terminal voltage V_{C} is merely observed to be asymptotic to VB/2 so that in a strict sense, there is no voltage of VB/2 generated. However, from a different viewpoint, an electrical charge q supplied from the power in a state where the capacitor C₁ for dividing voltage and the capacitor C₀ are connected in series is converted into 2q, which is twice the q, in a state where the capacitor C₁ for dividing voltage and the capacitor C₀ are connected in parallel. Therefore, according to the principle of the conservation of energy, it can be considered to be equivalent to the battery voltage VB being halved into VB/2.

If the both-terminal voltage of the capacitor C₁ for dividing voltage is V_{C1}, each of the both-terminal voltages when in a state of the left side in FIG. 5 is obtained by the following Expressions 1 and 2.

V_{C}=C₀×VB/(C₀+C₁). (Expression 1)

V_{C1}=C₁×VB/(C₀+C₁). (Expression 2)

At this time, if the electrical charges stored in the capacitor C₀and the capacitor C₁ for dividing voltage are respectively q₀ and q₁, and if the sum of the electrical charges stored in the capacitor C₀ and the capacitor C₁ for dividing voltage is qₐₗₗ when in a state of the right side in FIG. 5, the following Expression 3 is obtained.

$$\begin{matrix}{q}_{all} = {q}_{0} + {q}_{1} \\ = {C}_{0} \times {C}_{1} \times VB / ( {C}_{0} + {C}_{1} ) + {C}_{0} \times {C}_{1} \times VB / ( {C}_{0} + {C}_{1} ) \\ = 2 \times {C}_{0} \times {C}_{1} \times VB / ( {C}_{0} + {C}_{1} )\end{matrix} \qquad ( Expression 3 )$$

If the both-terminal voltage of the capacitor C₀ and the capacitor C₁ for dividing voltage at this time is Vₐₗₗ (1), the following Expression 4 is obtained.

$$\begin{matrix}{V}_{all} ( 1 ) = {q}_{all} / ( {C}_{0} + {C}_{1} ) \\ = 2 \times {C}_{0} \times {C}_{1} \times VB / {( {C}_{0} + {C}_{1} )}^{2}\end{matrix} \qquad ( Expression 4 )$$

If the both-terminal voltage of the capacitor C₀and the capacitor C₁ for dividing voltage, after repeating the states of the left and the right in FIG. 5 k times, is Vₐₗₗ (k), the following approximation is obtained.

$$\begin{matrix}{V}_{all} ( k + 1 ) = {V}_{all} ( k ) + Δ {q}_{all} / ( {C}_{0} + {C}_{1} ) \\ = {V}_{all} ( k ) + 2 \times {C}_{0} \times {C}_{1} \times ( VB - 2 \times {V}_{all} ( k ) ) / {( {C}_{0} + {C}_{1} )}^{2}\end{matrix}$$

Here, if k→∞, since Vₐₗₗ (∞) is converged, Δqₐₗₗ→0 is obtained. Therefore, VB−2×Vₐₗₗ (∞)→0, that is, it is converged on Vₐₗₗ (∞) →B/2.

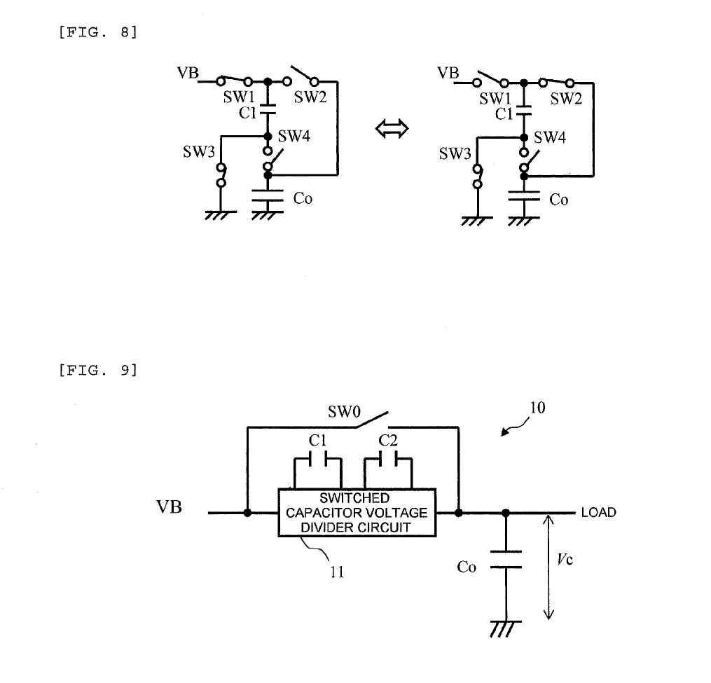

FIG. 6 is a diagram illustrating connection states of the capacitor C₀and the capacitor C₁ for dividing voltage in Mode 1. In a state of the left side in FIG. 6, the switch SW1 is closed and the capacitor C₁ for dividing voltage is connected to the power side, and the switch SW2 is open and the capacitor C₀ is disconnected from the power. In a state of the right side in FIG. 6, the switch SW1 is open and each of the capacitors is disconnected from the power, and the switch SW2 is closed and the capacitor C₁ for dividing voltage and the capacitor C₀ are connected in parallel. In this state, the electrical charge stored in the capacitor C₁ for dividing voltage moves to the capacitor C₀.

It is possible to realize the same operation as a switched capacitor in a narrow sense which is used in an analog filter and the like by repeating the states of the left and the right in FIG. 6. If a switching frequency in this operation is f, the switched capacitor voltage divider circuit 11 becomes equivalent to resistance, that is, R=1/(fC₁).

As illustrated in FIG. 4, first, the both-terminal voltage V_{C} of the capacitor. C₀ is asymptotic to VB/2 in Mode 2 and subsequently, is asymptotic to VB in Mode 1 by adopting Mode 2 and Mode 1 described in FIGS. 5 and 6. When a voltage change curve of the both-terminal voltage V_{C} is viewed microscopically, as illustrated in the enlarged ellipse in FIG. 4, the curve rises in steps in accordance with the switching operation.

FIG. 7 is a diagram illustrating detailed configurations of the switched capacitor voltage divider circuit 11 and operations in Mode 2. States of the left and the right in FIG. 7 respectively correspond to the states of the left and the right in FIG. 5. In the state of the left side in FIG. 7, switches SW1 and SW4 are closed and switches SW2 and SW3 are open so that the capacitor C₁ for dividing voltage and the capacitor C₀ are connected in series. In the state of the right side in. FIG. 7, the switches SW2 and SW3 are closed and the switches SW1 and SW4 are open so that the capacitor C₁ for dividing voltage and the capacitor C₀ are connected in parallel. This operation is repeatedly carried out, thereby realizing the operations in Mode 2.

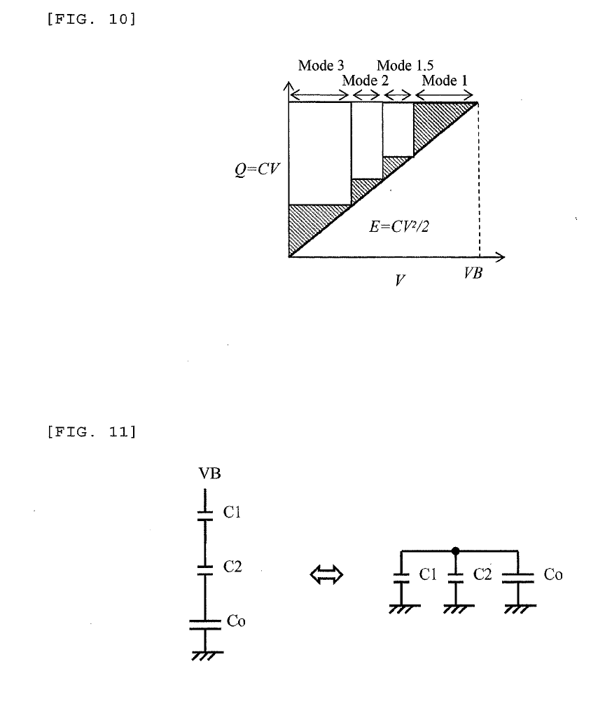

FIG. 8 is a diagram illustrating detailed configurations of the switched capacitor voltage divider circuit 11 and operations in Mode 1. States of the left and the right in FIG. 8 respectively correspond to the states of the left and the right in FIG. 6. In the state of the left side in FIG. 8, switches SW1 and SW3 are closed and switches SW2 and SW4 are open so that the electrical charge supplied from the power (VB) is stored in the capacitor C₁ for dividing voltage. In the state of the right side in FIG. 8, the switches SW2 and SW3 are closed and the switches SW1 and SW4 are open so that the electrical charge stored in the capacitor C₁ for dividing voltage is moved to the capacitor C₀. This operation is repeatedly carried out, thereby realizing the operations in Mode 1.

### Embodiment 1: Conclusion

As in the above, the precharge circuit 10 according to the embodiment 1 divides the battery voltage VB using the switched capacitor voltage divider circuit 11 and can gradually store the electrical charge in the capacitor C₀. Accordingly, it is possible to realize a soft-start precharge circuit.

Specifically, since a potential difference between the both-terminal voltage V_{C} of the capacitor C₀ and an applied voltage can be alleviated by the switched capacitor voltage divider circuit 11, it is possible to reduce the loss (generation of heat) in the precharge circuit 10.

In addition, the precharge circuit 10 according to the embodiment 1, the connection state between the capacitor C₁ for dividing voltage and the capacitor C₀, is switched between Mode 1 and Mode 2, thereby switching the both-terminal voltage V_{C} of the capacitor C₀ in two phases of VB/2 and VB. Accordingly, it is possible to reduce the loss (generation of heat) in the precharge circuit 10 by half.

Furthermore, as a method of suppressing the both-terminal voltage of the capacitor C₀, from a viewpoint of reducing the loss, a method of using a chopper and a method of dividing a voltage by a switched capacitor can be considered. When the switched capacitor voltage divider circuit 11 is adopted as in the invention, there is no need for a choke coil. Therefore, it is considered that a method according to the invention is suitable particularly for use with low electric power.

### Embodiment 2

FIG. 9 is a schematic circuit diagram of the precharge circuit 10 according to an embodiment 2 of the invention. The precharge circuit 10 according to the embodiment 2 includes two capacitors (C₁ and C₂) for dividing voltage. When there are two capacitors for dividing voltage, it is possible to realize Mode 3 in which the voltage division ratio, is 1/3, Mode 2. in which the voltage division ratio is 1/2, and Mode 1 in which the voltage division ratio is 1. Moreover, it is possible to realize Mode 1.5 in which the voltage division ratio is 2/3 by studying combinations of capacitors.

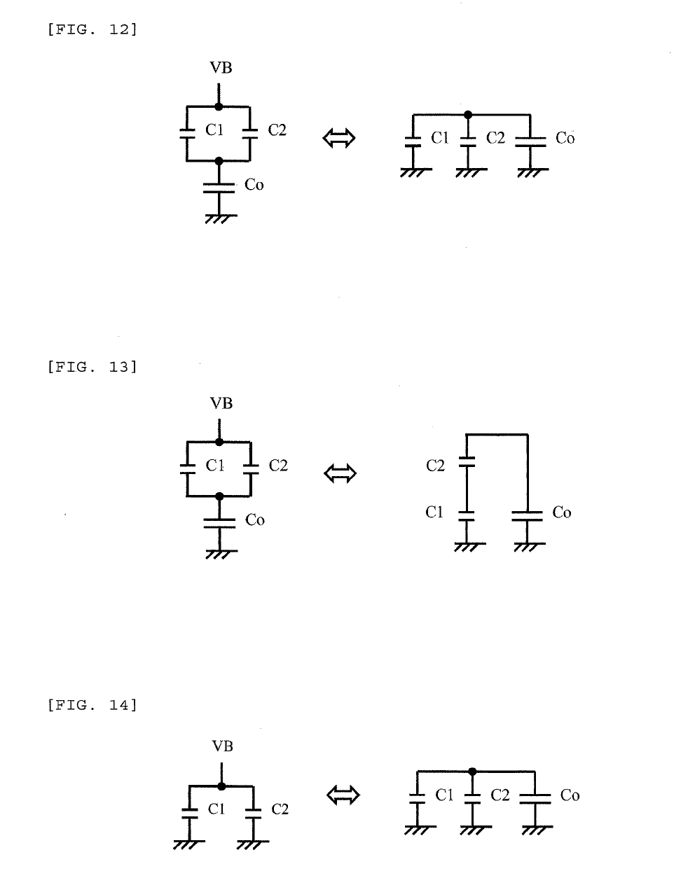

FIG. 10 is a diagram illustrating a state of a change in switching a voltage applied to both, terminals of the capacitor C₀ according to the embodiment 2: In the embodiment 2, it is possible to change the both-terminal voltage V_{C} in four phases.

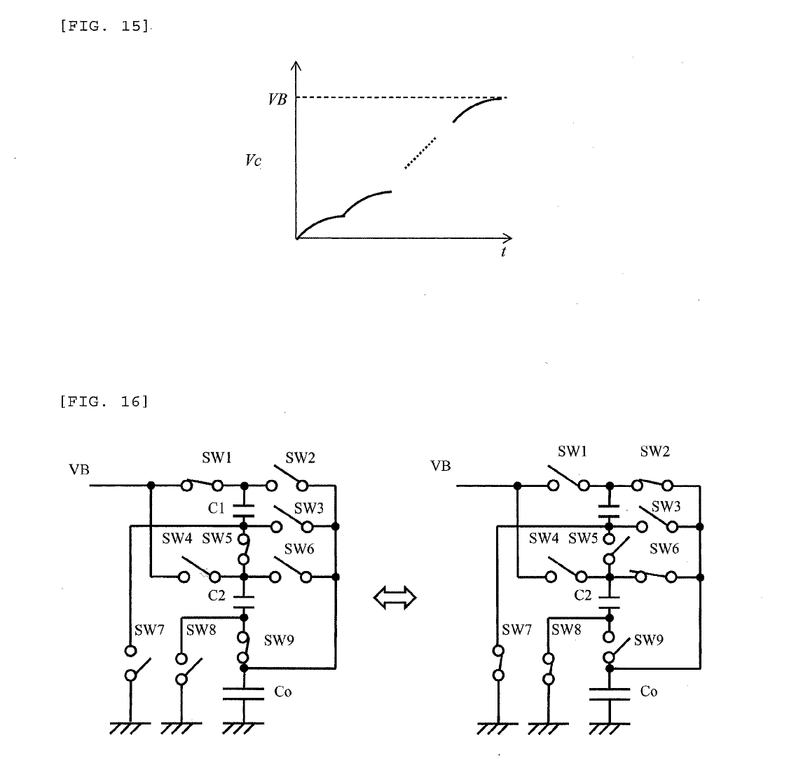

FIG. 11 is a diagram illustrating connection states,of the capacitor C₀ and the capacitors for dividing voltage in Mode 3. The controller 12, in Mode 3, causes the capacitor C₀ and the capacitors (C₁ and. C₂) for dividing voltage to repeatedly alternate between the state of being connected in series and the state of being connected in parallel. Accordingly, the battery voltage VB is divided into VB/3.

FIG. 12 is a diagram illustrating connection states of the capacitor C₀ and the capacitors for dividing, voltage in Mode 2. The controller 12, in Mode 2, causes the capacitor C₀ and the capacitors (C₁ and C₂) for dividing voltage to repeatedly alternate between the state of being connected in series and the state of being connected in parallel . In a state of the left side in FIG. 12, the capacitors C₁ and C₂ for dividing voltage are connected to each other in parallel. Accordingly, the battery voltage VB is divided into VB/2.

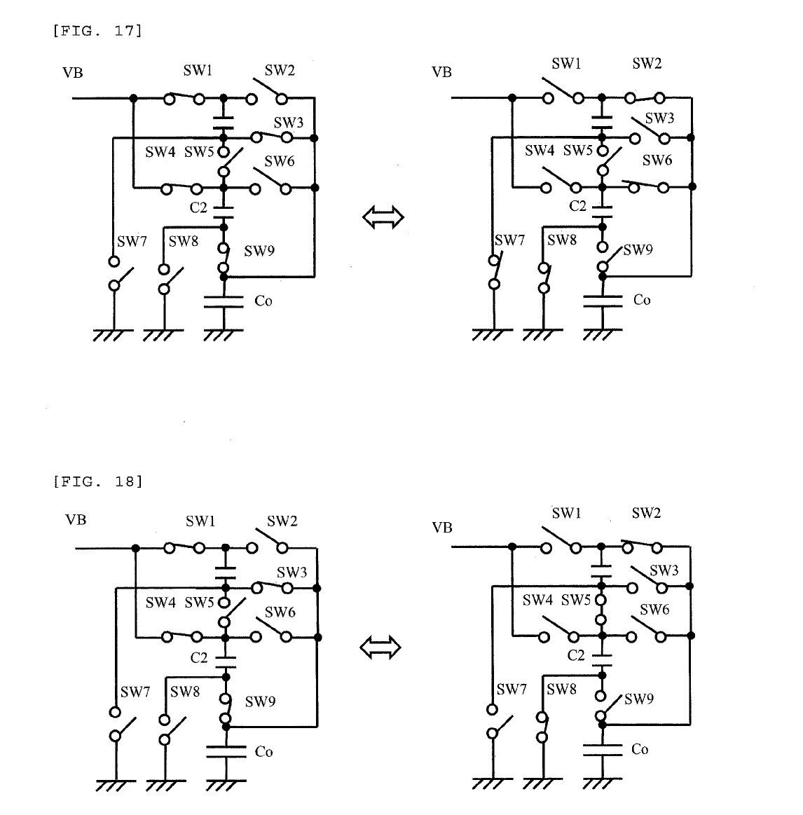

FIG. 13 is a diagram illustrating connection states of the capacitor C₀ and the capacitors for dividing voltage in Mode 1.5. The controller 12, in. Mode 1.5, causes the capacitor C₀ and the capacitors (C₁ and C2) for dividing voltage to repeatedly alternate between a state of being connected in series and the state of being connected in parallel. In a state of the left side in FIG. 13, the capacitors C₁ and C₂ for dividing voltage are connected to each other in parallel. In a state of the right side in FIG. 13, the capacitors C₁ and C₂ for dividing voltage are connected to each other in series, and these two capacitors for dividing voltage, and the capacitor C₀ are connected to each other in parallel. Accordingly, the battery voltage VB is divided into 2VB/3.

FIG. 14 is a diagram illustrating connection states of the capacitor C₀ and the capacitors for dividing voltage in Mode 1. The controller 12, in Mode 1, repeatedly alternate between the state where the capacitor C₀ is disconnected from the power and the capacitors (C₁ and C₂) for dividing voltage are connected in parallel and the state where these three capacitors are mutually connected in parallel. Accordingly, the the battery voltage VB is divided into VB/2.

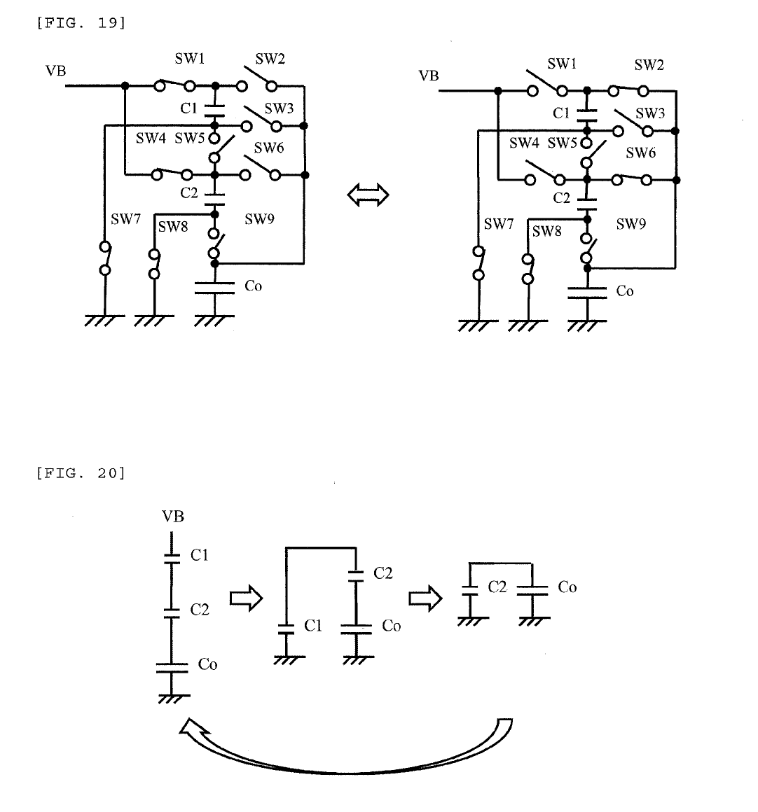

FIG. 15 is a diagram illustrating a change in the both-terminal voltage V_{C} of the capacitor C₀ according to the embodiment 2, As illustrated in FIG. 15, according to the embodiment 2, the both-terminal voltage V_{C} gradually increases from a low voltage to high voltage, and thus, it is possible: to reduce the loss (generation of heat) in the precharge circuit 10.

FIG. 16 is a diagram illustrating detailed configurations of the switched capacitor voltage divider circuit 11 and operations in Mode 3 according to the embodiment 2. States of the left and the right in FIG. 16 respectively correspond to the states of the left and the right in FIG. 11. In the state of the left side in FIG. 16, switches SW1, SW5 and SW9 are closed and switches, SW2, SW3, SW4, SW6, SW7 and SW8 are open so that the capacitors (C₁ and C₂) for dividing voltage and the capacitor C₀ are connected in series. In the state of the right side in FIG. 16, the switches SW2, SW6, SW7 and SW8 are closed and the switches SW1, SW3, SW4, SW5 and SW9 are open so that every capacitor is connected in parallel with each other. This operation is repeatedly carried out, thereby realizing the operations in Mode 3.

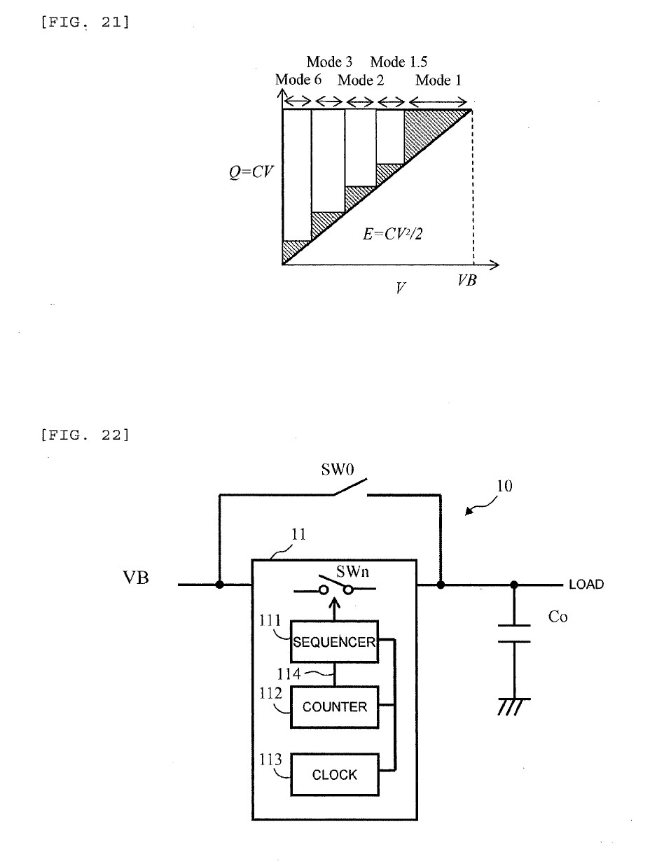

FIG. 17 is a diagram illustrating detailed configurations of the switched capacitor voltage divider circuit 11 and operations in Mode 2 according to the embodiment 2. States of the left and the right in FIG. 17 respectively correspond to the states of the left and the right in FIG. 12. In the state of the left side in FIG. 17, switches SW1, SW3, SW4 and SW9 are closed and switches SW2, SW5, SW6, SW7 and SW8 are open so that a combined capacitance in which the capacitors C₁ and C₂ for dividing voltage are connected in parallel is connected in series with the capacitor C₀. In the state of the right side in FIG. 17, the switches SW2, SW6, SW7 and SW8 are closed and the switches SW1, SW3, SW4, SW5 and SW9 are open so that every capacitor is connected in parallel with each other. This operation is repeatedly carried out, thereby realizing the operations in Mode 2.

FIG. 18 is a diagram illustrating detailed configurations of the switched capacitor voltage divider circuit 11 and operations in Mode 1.5 according to the embodiment 2. States of the left and the right in FIG. 18 respectively correspond to the states of the left and the right in FIG. 13. In the state of the left side in FIG. 18, switches SW1, SW3, SW4 and SW9 are closed and switches SW2, SW5, SW6, SW7 and SW8 are open so that the combined capacitance in which the capacitors C₁ and C2 for dividing voltage are connected in parallel is connected in series with the capacitor C₀. In the state of the right side in FIG. 18, the switches SW2, SW5, and SW8 are closed and the switches SW1, SW3, SW4, SW6, SW7 and SW9 are open so that the capacitors C₁ and C₂ for dividing voltage are connected in series. Furthermore, these two capacitors for dividing voltage and the, capacitor C₀ are connected in parallel. This operation is repeatedly carried out, thereby realizing the operations in Mode 1.5.

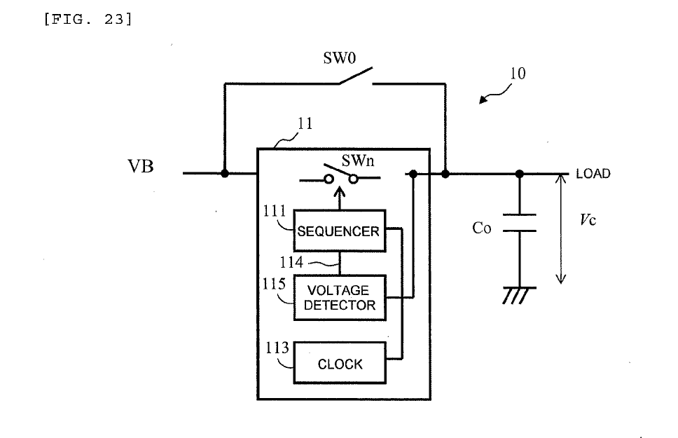

FIG. 19 is a diagram illustrating detailed configurations of the switched capacitor voltage divider circuit 11 and operations in Mode 1 according to the embodiment 2. States of the left and the right in FIG. 19 respectively correspond to the states of the left and the right in FIG. 14. In the state of the left side in FIG. 19, switches SW1, SW4, SW7 and SW8 are closed and switches SW2, SW3, SW5, SW6 and SW9 are open so that the capacitor C₀ is disconnected from the power and then, the capacitors C₁and C₂ for dividing voltage are connected in parallel. In the state of the right side in FIG. 19, the switches SW2, SW6, SW7 and SW8 are closed and the switches SW1, SW3, SW4, SW5, and SW9 are open so that every capacitor is connected in parallel. This operation is repeatedly carried out, thereby realizing the operations in Mode 1.

### Embodiment Conclusion

As in the above, the precharge circuit 10 according to the embodiment 2 includes two capacitors for dividing voltage and switches the connection state between the capacitors for dividing voltage and the capacitor C₀ and the connection state between the capacitors for dividing voltage. Accordingly, four operation modes are realized, and it is possible to gradually increase the both-terminal voltage V_{C} by switching in four phases.

### Embodiment 3

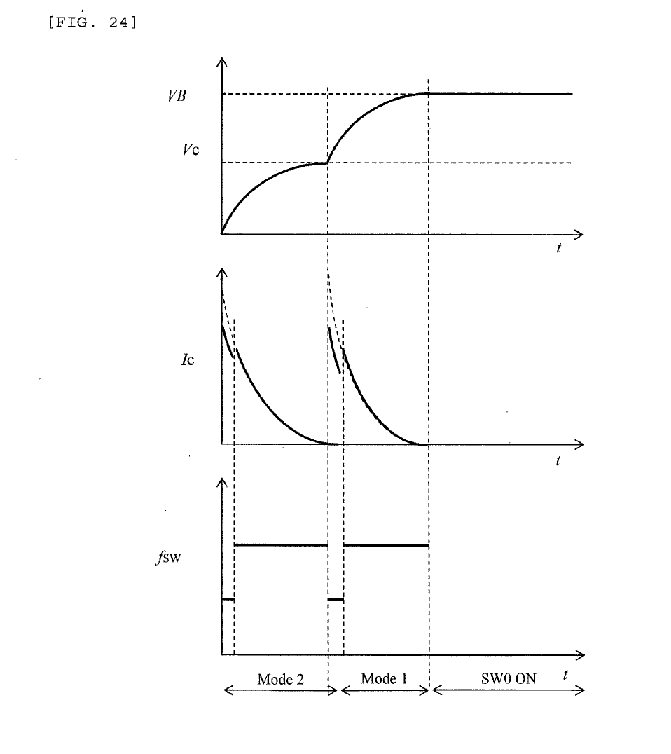

FIG. 20 is a schematic circuit diagram of, the precharge circuit 10 according to an embodiment 3 of the invention. As illustrated in FIG. 20, it is possible to realize Mode 6 dividing the battery voltage VB into VB/6 by repeating three states that are (a) a state where the capacitors C₁and C₂ for dividing voltage and the capacitor C₀are connected in series, (b) a state where the electrical charge of the capacitor C₁ for dividing voltage is moved to the combined capacitance in which the capacitor C₂ for dividing voltage and the capacitor C₀ in series connection, and (c) the electrical charge of the capacitor C₂ for dividing voltage is moved to the capacitor C₀.

FIG. 21 is a diagram illustrating a change in the both-terminal voltage V_{C} of, the capacitor C₀ according to the embodiment 3. As illustrated in FIG. 21, it is possible to reduce the loss (generation of heat) further than in a case of the embodiment 2 by carrying out Mode 6 at the first stage of charging,

### Embodiment 4

FIG. 22 is a diagram illustrating an example of a control circuit of the switched capacitor voltage divider circuit 11 according to an embodiment 4 of the invention. A configuration and an operation of each switch are the same as those of the embodiments 1 to 3.

In the example of the circuit illustrated in FIG. 22, the switched capacitor voltage divider circuit 11 includes a sequencer 111, a counter 112 and a clock 113. The counter 112 measures the time elapsed since the power is supplied in accordance with a reference clock that is output by the clock 113. After elapse of a predetermined period of time, the counter 112 outputs a mode switching signal 114 (for example, a signal that commands switching from Mode 1 to Mode 6 of FIG. 21) to the sequencer 111. The sequencer 111 opens and closes the switch group SWn in accordance with a mode designated by the mode switching signal 114.

FIG. 23 is a diagram illustrating another configuration example of a control circuit of the switched capacitor voltage divider circuit 11 according to the embodiment 4. In the example of the circuit illustrated in FIG. 23, in place of the counter 112, a voltage detector 115 is included. The voltage detector 115 detects the both-terminal voltage V_{C} of the capacitor C₀ and outputs the mode switching signal 114 to the sequencer 111 when the voltage reaches a predetermined value. The both-terminal voltage V_{C} corresponds to the electrical charges stored in the capacitor C₀.

In FIG. 23, the voltage detector 115 may be set to measure a terminal voltage of the capacitor for dividing voltage in place of the both-terminal voltage of the capacitor C₀. In this case, the both-terminal voltage V_{C} of the capacitor C₀ can be obtained by calculation. Similarly, it is possible to measure the electrical charge stored in the capacitor for dividing voltage.

### Embodiment 4: Conclusion

As in the above, the precharge circuit 10 according to the embodiment 4 switches the mode of the switched capacitor voltage divider circuit 11, based on the time elapsed, the terminal voltage of the capacitor for dividing voltage and the capacitor C₀, and the electrical charge stored in the capacitor for dividing voltage and the capacitor C₀. When based on the time elapsed, Mode is switched after elapse of a predetermined period of time since the power is supplied. When based on the terminal voltage or the stored electrical charge, the terminal voltage is measured, and the stored, electrical charge is further calculated using the capacitance of each capacitor as needed, thereby switching Mode when these values reach a predetermined value. Otherwise, Mode may be switched when a ratio of the electrical charges respectively stored in the capacitor C₀ and the capacitor for dividing voltage reaches a predetermined proportion.

In the example of the circuit illustrated in FIG. 22, since there is no need for the voltage detector 115, it is possible to configure the precharge circuit 10 with a simpler circuit. Accordingly, it is possible to reduce a failure rate of the circuit and enhance reliability. Meanwhile, in the example of the circuit illustrated in FIG. 23, even if the both-.terminal voltage V_{C} is no longer in the designed value due to a fluctuation in the constant of VB or C₀, it is possible to carry out the operation in accordance with the fluctuation.

According to the precharge circuit 10 described in the above embodiments 1 to 4, since the loss (generation of heat) in the precharge circuit 10 can be reduced, it is possible to cause a circuit configured with a large-sized resistor in the related art to be realized in a compact-type LSI (ASIC: IC for specific use) and the like. In this case, since the switched capacitor voltage divider circuit 11 can be integrated in one chip of LSI, it is possible to reduce the entire apparatus in size. Furthermore, the capacitor for dividing voltage can be externally attached outside the LSI or can be internally mounted inside the LSI.

### Embodiment 5

FIG. 24 is a diagram illustrating time-dependent changes of the both-terminal voltage V_{C} and a capacitor charging current I_{C} in a case where a switching frequency fsw of the switched capacitor voltage divider circuit 11 is changeable. A configuration of the precharge circuit 10 is the same as those of the embodiments 1 to 4. In a graph illustrating the charging current I_{C} in FIG. 24, the charging current when the switching frequency fsw is fixed is illustrated by a dotted line, and the charging current when the switching frequency fsw is changeable is illustrated by a solid line.

In the example illustrated in FIG. 24, at the initial stage of each mode in which the charging current I_{C} increases, the controller 12 lowers the switching frequency fsw so as to suppress the charging current I_{C}. Accordingly, a peak value of the charging current I_{C} is suppressed, and thus, it is possible to, prevent the generation of heat from being concentrated.

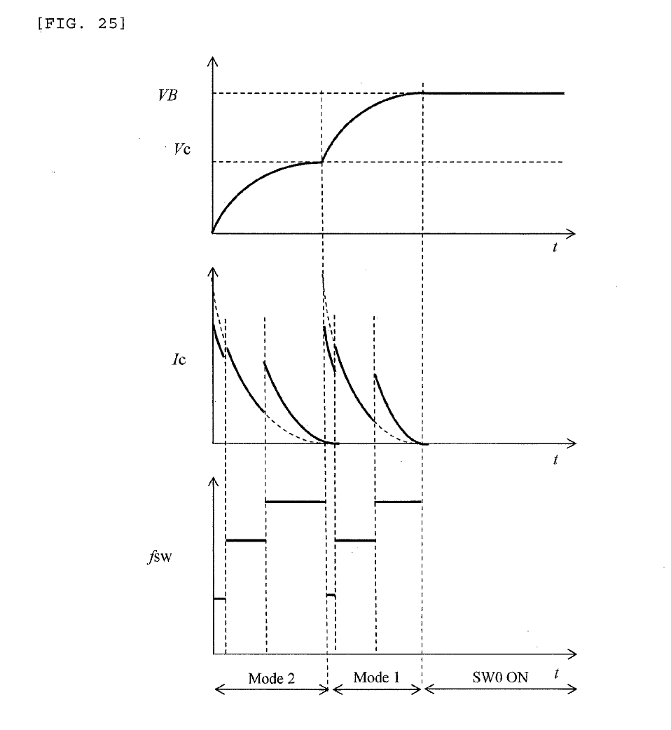

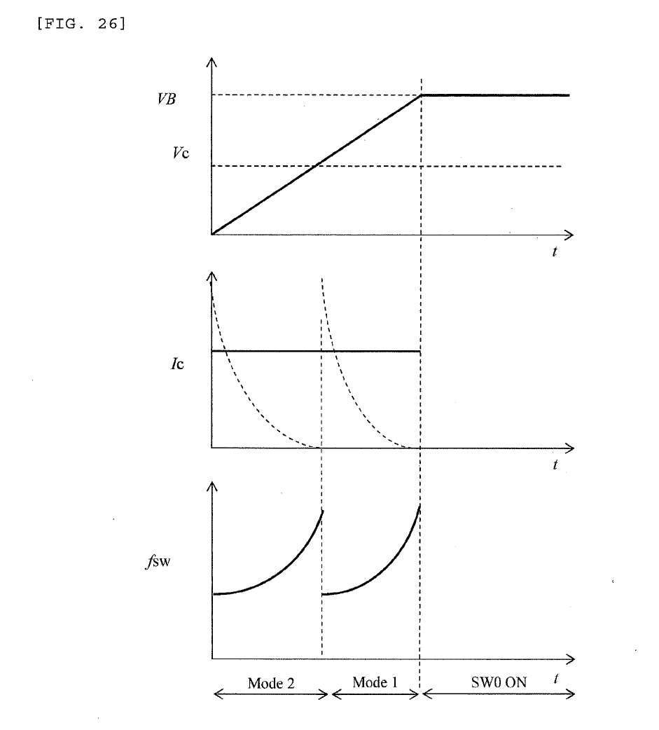

FIG. 25 is a diagram illustrating an example of a case where the switching frequency fsw is changed in an aspect different from that of FIG. 24. In the example illustrated in FIG. 25, in the latter half of each mode in which the charging current I_{C} descends, the switching frequency fsw is increased in order to increase the charging current I_{C}. Accordingly, the charging current I_{C} is controlled to suppress the peak value, and it is possible to increase the charging current I_{C} in the latter half of the mode in order to shorten a charging period while the generation of heat is prevented from being concentrated.

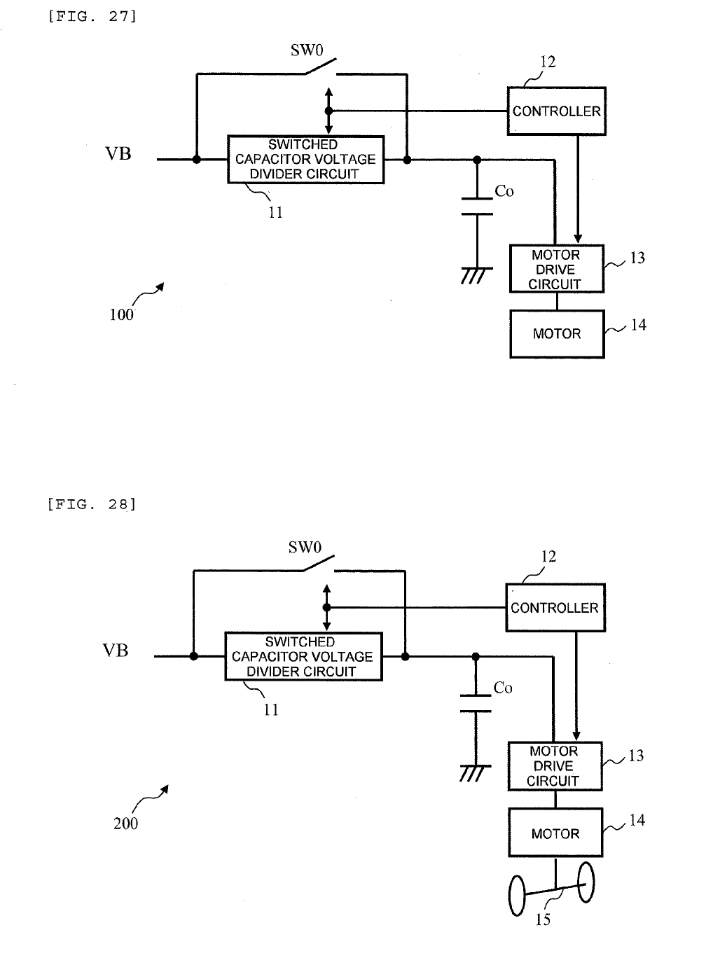

FIG. 26 is a diagram illustrating an example of a case where the switching frequency fsw is changed in another aspect different from those of FIGS. 24 and 25. In the example illustrated in FIG. 26, the switching frequency fsw decreases at the initial stage of each mode and gradually increases thereafter.

In addition to the examples illustrated in FIGS. 24 to 26, it is possible to provide a temperature sensor in a semiconductor device configuring the switched capacitor voltage divider circuit 11 and to change, the switching frequency fsw in accordance with a temperature detected by the temperature sensor. For example, the controller 12 lowers the switching frequency fsw when the temperature is high and increases the switching frequency fsw as the temperature becomes low to suppress the charging current I_{C}, and thus, it is possible to prevent the generation of heat.

### Embodiment 6

FIG. 27 is a configuration diagram of a motor drive system 100 according to an embodiment 6 of the invention. The motor drive system 100 has a motor drive circuit 13 and a motor 14 as loads of the precharge circuit 10 described in the embodiments 1 to 5. The controller 12 controlling the switched capacitor voltage divider circuit 11 also can serve as a controller controlling the motor drive circuit 13.

When supplying the power, the capacitor C₀ is charged with the electrical charge via the switched capacitor voltage divider circuit 11. When in a regular operation, the electrical charge is charged to the capacitor C₀ via the switch SW0. The energy stored in the capacitor C₀ is supplied to the motor 14 via the motor drive circuit 13 when a large amount of energy is instantaneously needed.

### Embodiment 7

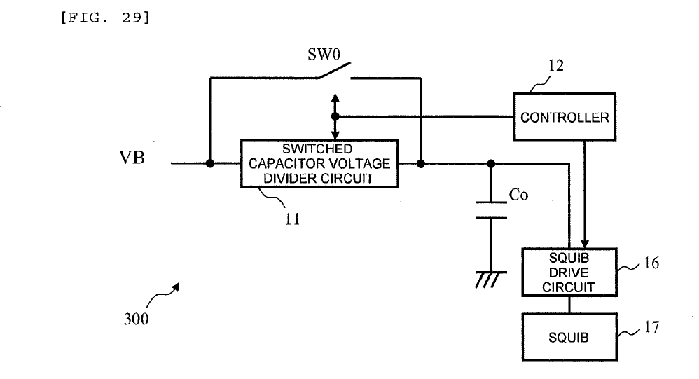

FIG. 28 is a configuration diagram of an electric power steering system 200 according to an embodiment 7 of the invention. The electric power steering system 200 has the motor drive circuit 13 and the motor 14 as the loads of the precharge circuit 10 described in the embodiments 1 to 5. The motor 14 drives a steering mechanism 15 of the electric power steering system 200.

The steering mechanism 15 instantaneously needs a large amount of electric power and it is possible to effectively utilize the capacitor C₀ which is charged using the precharge circuit 10 according to the invention.

### Embodiment 8

FIG. 29 is a configuration diagram of an airbag system 300 according to an embodiment 8 of the invention. The airbag system 300 has a squib drive circuit 16 and a squib 17 as a load of the precharge circuit 10 described in'the embodiments 1 to 5.

When a motor vehicle receives a shock due to a collision and the like, energy stored in the capacitor C₀ is supplied to the squib 17 via the squib drive circuit 16, and thereby it is possible to inflate an airbag by igniting the squib 17. The squib 17 instantaneously needs the large amount of electric power and it is possible to effectively utilize the capacitor C₀ which is charged using the precharge circuit 10 according to the invention.

### REFERENCE SIGNS LIST

10: precharge circuit, 11: switched capacitor voltage divider circuit, 12: controller, 13: motor drive circuit, 14: motor, : steering mechanism, 16: squib drive circuit, 17: squib, 100: motor drive system, 200: electric power steering system, 300: airbag system, C₀: capacitor, C₁ and C₂: capacitors for dividing voltage, SW0 to SW9: switches

1. A capacitor precharge circuit charging a capacitor which is connected in parallel with a load comprising:
a voltage divider capacitor that is connected to the capacitor; and
a switch that alternately switches whether or not the capacitor is connected to a power,
wherein the switch further switches whether the capacitor and the voltage divider capacitor are connected in parallel or in series.

2. The capacitor precharge circuit according to claim 1,
wherein a plurality of voltage divider capacitors are provided, and
the switch switches a connection state between the plurality of voltage divider capacitors.

3. The capacitor precharge circuit:according to claim 2,
wherein the switch switches at least any two of the plurality of voltage divider capacitors to be connected in parallel or in series.

4. The capacitor precharge circuit according to claim 1, further comprising:
a controller that controls an operation of the switch,
wherein the controller controls the operation of the switch so as to cause a terminal voltage of the capacitor to increase in accordance with an elapse of a period of time since the power is supplied.

5. The capacitor precharge circuit according to claim 1, further comprising:
a controller that controls an operation of the switch,
wherein the controller controls the operation of the switch so as to cause a voltage division ratio showing a proportion allocated to the capacitor with respect to the power supply voltage to increase in accordance with an elapse of a period of time since the power is supplied.

6. The capacitor precharge circuit according to claim 1, further comprising
a controller that controls an operation of the switch,
wherein the controller controls the operation of the switch so as to cause an electrical charge conversion ratio showing a proportion supplied to the capacitor with respect to an amount of an electrical charge supplied from the power to increase in accordance with an elapse of a period of time since the power is supplied or with an increase of the terminal voltage of the capacitor.

7. The capacitor precharge circuit according to claim 1, further comprising:
a controller that controls an operation of the switch,
wherein the controller changes a frequency at which the switch switches whether or not the capacitor is connected to the power while charging the capacitor.

8. The capacitor precharge circuit according to claim 7,
wherein the controller sets to be higher than before the frequency at the time when the switch switches a connection state between the capacitor and the voltage divider capacitor at the time after elapse of a predetermined period of time since the switch switches the connection state between the capacitor and the voltage divider capacitor.

9. The capacitor precharge circuit according to claim 7,
wherein the controller sets the frequency to be low as a temperature of the capacitor precharge circuit rises.

10. The capacitor precharge circuit according to claim 1,
wherein the switch is configured to include a plurality of substitute switches, and
the plurality of substitute switches are mounted inside the same semiconductor element.

11. A motor drive system comprising:
the capacitor precharge circuit according to claim 1; and
a motor drive circuit that is connected in parallel with the capacitor.

12. An electric power steering system comprising:
the capacitor precharge circuit according to claim 1;
a motor drive circuit that is connected in parallel with the capacitor;
a motor that is driven by the motor drive circuit; and
a steering mechanism that is driven by the motor.

13. An airbag system comprising:
the capacitor precharge circuit according to claim 1;
a squib drive circuit that is connected in parallel with the capacitor; and
a squib that is driven by the squib drive circuit.
